(19) United States
(12) Patent Application Publication
(10) Pub. No.: US 2006/0122850 A1
(43) Pub. Date: Jun. 8, 2006

(54) Real-time Professional Services Facilitator system and method

(76) Inventors: Mateo Dylan Ward, Miami, FL (US); Steven Brian Sikes, Miami, FL (US); Robin Padberg, Miami, FL (US)

Correspondence Address: STEVEN SIKES, 4070 WOODRIDGE RD, MIAMI, FL, 33133, US

(21) Appl. No.: 10/904,937

(22) Filed: Dec. 6, 2004

(51) Int. Cl. G06Q 99/00

(52) U.S. Cl. 705/1

(57) ABSTRACT

A method and system enabling users to access a plurality of professional service providers and knowledge experts to engage their services in real-time over the global computer networks and mobile phones. Prior to scheduling a session, the user has the option to bid on the services of a provider or expert in an online trading environment or to “purchase now” by making an instantaneous payment, or by subscription. The system and method enables sessions and events to be scheduled online and delivered via any combination of voice, video, and text over either a wired or wireless connection to the Internet, instant messaging applications, personal digital assistants, mobile phones, or any specialized communications device that can support interactive delivery of professional services and real-time solutions and guidance. The abovementioned interfaces over which the real-time professional services will be delivered are hereinafter collectively referred to as “Global Communications Networks.”

### FIELD OF THE INVENTION

The present invention is in the field of e-Commerce, specifically a system and method to provide real-time professional services and information and knowledge on demand to individuals and organizations for purchase in an online trading platform.

### BACKGROUND OF THE INVENTION

Several factors have contributed to the genesis of this invention: the ever-expanding demand for professional services, advances in data transmission, the growth of the on-demand information economy, the rapid expansion of the Global Communications Networks, the accelerated adoption of mobile applications and global communication network tools, the growth of the online trading environment, the expansion of the search engine market, and the personalized and customized online experience via profiling, compatibility, scheduling, and matchmaking technologies.

This system and method of delivery will accommodate a society and economy that is more mobile, omni-connected, and info-customer-centric. Personal experts available on real-time demand will become more common; this invention will fulfill the needs of a global economy in which knowledge capital is the most viable path to achieving goals, finding solutions and enhancing skills.

The invention relates to a system and method for delivering real-time professional services to individuals and organizations over the Global Communications Networks via a trading platform with listing, profiling, searching, matchmaking, online settlement, authentication, scheduling, reservation, delivery, feedback, and rating components. The instant dissemination of knowledge capital by experts who specialize in providing professional services in several fields, including education, healthcare, law, accounting, financial planning and advising, sports & fitness training, information technology, advertisement and marketing, personal and executive training, and real estate is transforming the global economy so that individuals and organizations will always be able to connect with knowledge providers for support, guidance, information and advice. The online trading environment has created burgeoning e-Commerce communities of buyers and sellers of mostly products and tangible goods. With an accelerating economy and a greater emphasis on customer-centric technologies, more consumers and organizations will participate in an online trading environment to interact with knowledge experts over the global communications networks to receive fast and personalized solutions, information and guidance and to engage the skills and services of these knowledge expert providers just-in-time, anytime, anywhere.

Thereinafter, inventors have created and developed several methods and processes for facilitating delivery of professional services and knowledge capital over the global computer networks. U.S. Pat. No. 6,393,412 to Deep (2002) delineates a process and method for enabling users to purchase professional services through an ongoing service fee of credits and coupons, with services delivered in a private chat room through a service brokerage via the Internet. The delivery of the services is exclusive to an online chat environment and does not provide a trading platform or format as a payment method, nor does it provide for pre-scheduled appointments at a specific future date and time. It also does not include a search compatibility tool to match users to the most appropriate provider and does not have a master provider database for the chat sessions. U.S. Pat. No. 5,862,223 to Walker, et al. (1999) describes a process and method for facilitating cryptographically-assisted delivery of expert-based support to an end user based on a specific expert request. This present invention lacks trading and scheduling components and the delivery of expert data is asynchronous, as opposed to a real-time environment where there is an interactive exchange between/among the user(s) and knowledge expert(s). U.S. Pat. No. 6,669,485 to Theon et al. (2003) consists of a real-time collaborative learning method by soliciting experts over the global communications networks; however, the system does not offer real-time professional services and lacks scheduling and online trading components. U.S. Pat. No. 6,507,726 to Atkinson et al. (2003) focuses on a curriculum scheduling component designed exclusively for the e-learning environment, but it does not offer real-time professional services outside the educational sphere and it does not have an online trading component. U.S. Pat. No. 6,496,681 to Linton (2002) consists of a method and system for assessing and managing educator/student skills via an e-learning application, but the invention does not encompass other activities and services outside of education; moreover, there are no online trading and scheduling components. U.S. Pat. No. 6,358,053 to Rosenfield (2002) focuses on providing online interactive language instruction and it also has a profiling component; however, the invention is limited to language instruction and it does not enable the individual to choose the provider; moreover, there is no online trading environment.

There are inventions that present items and tangible goods for individuals to purchase in an online trading environment. U.S. Pat. No. 6,732,161 to Hess, et al. (2004) describes a method and system for managing and presenting information in an online trading environment. Thumbnail images of items for sale are listed for selection and bidding by prospective buyers. This invention focuses on the purchase of tangible goods and products as opposed to the real-time delivery of services and expertise by professional service providers. U.S. Pat. No. 6,732,161 to Hess, et al. (2004) describes a system for presenting and managing items for sale in an online trading environment and facilitating the person-to-person e-commerce transaction by allowing the prospective buyers to review items for sale; however, this patent does not comprise scheduling and real-time professional service components. U.S. Pat. No. 6,026,148 by Dworkin, et. al. describes a system and method for delivering expert information by computer; however, this invention does not deliver the information and/or expertise in real-time; i.e., there are no interactive sessions. This invention also lacks scheduling and online trading components.

Accordingly, existing inventions describe methods and systems for delivering e-learning applications or systems that enable individuals to engage the services of experts only in chat rooms, systems that present tangible goods for purchase in an online trading environment, and methods and systems for connecting experts with individuals in real-time for collaboration, but there does not appear to be an invention that possesses all the features and components of our system and method for delivering real-time services, by knowledge providers, over the global communication networks which are available for purchase in an online trading environment. To summarize, the systems and methods of the existing inventions have one or more of these disadvantages:
services are limited to e-learning applications;
services are not delivered in real-time;
services are provided only in group environments, forums, and in chat rooms;
services cannot be purchased in an online trading environment;
services cannot be scheduled for just-in-time, anytime (present or future), anywhere delivery.

In conclusion, the invention provides a convenient and customized system and method for delivery of real-time services with matchmaking, profiling, scheduling and online trading components. Because of the accelerated demand for instant information, the increased real-time interaction of individuals via messaging and global communication technology, and the worldwide adoption of online trading auctions, particularly by companies like eBay and Yahoo, this invention, the Real-time Professional Services Facilitator system and method, will solve the needs of a mobile society in which knowledge on demand, personalized attention, and the empowered consumer are becoming the norm. Moreover, the provider search engine feature of the invention is aligned with the strategies of companies like Google, Yahoo, and Microsoft who are currently expanding the traditional search engine market into new areas. The interactive features of the invention also touch upon the interactive services market currently being addressed by companies like Sony and Nokia. Finally, this invention creates a personalized online, ecommerce experience with the reviewing and profiling features that appear on the Amazon and eBay websites.

### SUMMARY OF THE INVENTION

The invention is generally focused on a method and system for the delivery and integration of real-time professional services over the Global Communications Networks via an online trading environment. The system provides an end-to-end service to users including selection, matchmaking, procurement, settlement, reservation, and delivery. Users will engage the services of knowledge experts after communicating their needs, selecting providers based on profiling or after accessing the website's search engine for a compatible match, and scheduling an online session or event, with a registered and screened knowledge provider from an extensive database. Thereinafter, the real-time event or session is delivered over the Global Communications Networks.

Users can review the profiles and ratings of providers before making a selection and can bid on the services of a provider for a scheduled event with a provider for the real-time delivery of services after making an instantaneous payment through a variety of payment methods which include but are not limited to pay pal, e-transaction, e-coupon, credit card, and monthly subscription.

The primary purpose of the present invention is to enable users to access the services of an extensive database of profiled, monitored and screened knowledge experts in real-time just-in time, anywhere, anytime, while accommodating the growing online trading environment and providing a personalized and customized interactive experience. Without this invention, it is unlikely any individual user would have access to such a broad selection of available service providers due to many factors, including time zones, geography, and most significantly, the lack of any centralized online professional service provider database.

Accordingly, the present invention provides a fast, easy, and convenient way for individuals and organizations to select randomly, and/or to connect with a database of registered and screened service providers by a matching system, to bid and purchase these services via an online trading environment, to schedule and engage the services of professional service providers synchronously, i.e., in real-time, over the Global Communication Networks and/or mobile phones. Finally, the present invention facilitates real-time interactive sessions and events in which users require the expertise or knowledge of providers during emergency situations or when there are specific time constraints.

### BRIEF DESCRIPTION OF THE DRAWINGS

FIG. 1 is a flow chart depicting the summary process of the preferred embodiment

FIG. 2 is a flow chart depicting the provider registration process of the preferred embodiment

FIG. 3 is a flow chart depicting the procurement process of the preferred embodiment

FIG. 4 is a flow chart depicting the settlement process of the preferred embodiment

FIG. 5 is a flow chart depicting the scheduling process of the preferred embodiment

FIG. 6 is a flow chart depicting the service delivery process of the preferred embodiment

### DETAILED DESCRIPTION OF THE PREFERRED EMBODIMENTS

In a preferred embodiment of the present invention, a new e-commerce hub is created that is focused primarily on professional services. There are a very large number of users and providers attracted to the hub so that the market for professional services grows exponentially due to the elimination of geographical, provider availability, and time zone parameters. Providers are screened and offer their services to users in an optimized fashion whereby schedules are submitted and frequently updated so that users have many choices of dates, times, and providers, while in a similar fashion, they can fill up their schedules with user appointments of all types from this newly created mass-market.

There are many potential ways that services can be listed by providers and located by users. The present invention will spawn a new market for search engines that specialize in searching for professional services. Services may be listed in an auction format, on bulletin boards, in specialized databases, or through networks of partner sites throughout the Internet or on mobile phone browsers. Once the user has identified the provider and time block they wish to purchase, they can either enter a bid under an online auction format or they can purchase the service immediately through established e-commerce methodologies. Once the purchase has been confirmed, the user may settle their account through any number of established online payment methods or even through value-added charges added to subscription services like mobile phone bills, cable TV bills, or DSL bills.

After the payment transaction and authorization have occurred, the user is able to formally book the session by providing a code or digital certificate through the scheduling module. The new confirmed reservation is then reflected on the public provider schedule as a blocked off unit of time that cannot be booked by other users. The only exception to this rule would be when a session has been previously scheduled as a group session or the user has invited other users to join the session in order to share the cost. A user will normally provide additional information to the provider through an online questionnaire or popup survey prior to the session so that the provider can customize the material to be covered to the user's specific needs and profile.

At the previously scheduled time, the provider will initiate the interactive session with the user. The process may also be set up whereby the user initiates the session or whereby both parties independently log on to a centralized interactive platform. Once the service is delivered and the session is over, both the user and the provider will have an opportunity to rate the performance of each party and this rating information can be made available to one or more parties, depending on the commercial application, and can be summarized and displayed as statistics to aid in future purchasing decisions or in advertising.

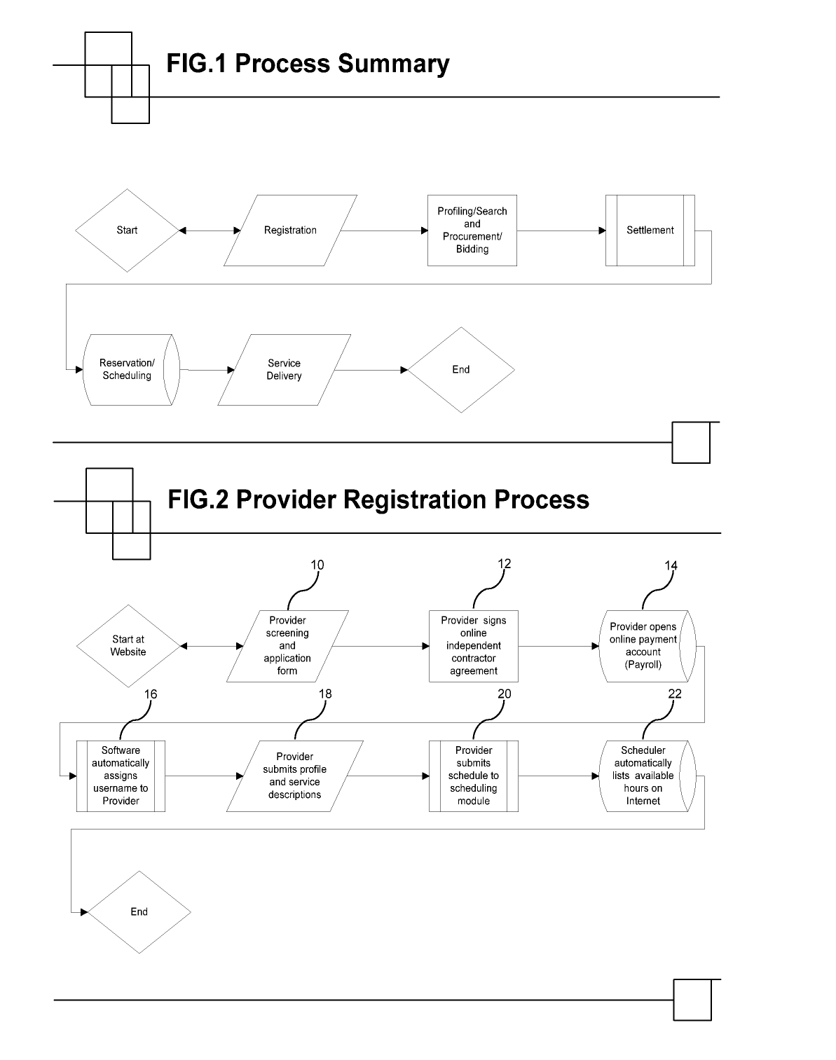

The preferred embodiment of the present invention will now be described in even greater detail by reference to FIGS. 1 through 6.

As shown in FIG. 1, the overall process follows an e-commerce transaction flow starting with registration of the providers and users; searching for the desired service at the specified time and date and then bidding on it or purchasing immediately; paying for the service using online settlement or subscription billing; reserving the specific time and date using the authorization provided by the successful completion of the settlement process; and finally the delivery of the service in a real-time interactive session.

FIG. 2 depicts the provider registration process whereby a provider completes a screening and application form 10 and auto-submits certified results to the Real-time Service Platform (RSP). The provider then signs an online independent contractor agreement 12 and opens an online payment account 14. The RSP assigns a username and password to the provider 16. The provider submits their professional profile and service descriptions 18, and weekly schedule 20 through the website which hosts the scheduling and reservation application as part of the RSP. The RSP automatically lists available hours on website 22 and other commercial online trading platforms (e.g. eBay, Amazon, etc.) Once providers are registered, they may also refer other providers to the RSP and may receive special consideration for their efforts. Providers may also collaborate on certain projects, provided that the user has agreed to the terms in advance.

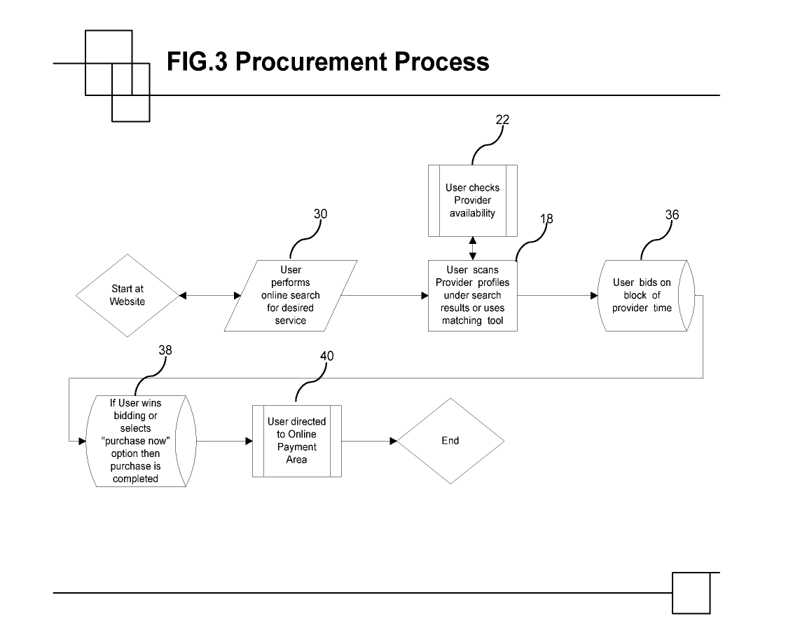

FIG. 3 depicts the service procurement process, whereby the user enters the online store, mobile web browser, or partner site (e.g. eBay, Amazon, etc.) and performs a search for the desired service 30. The user may be required to open an account with a username or password or in some cases may be able to make an emergency purchase without creating an account. In the case of an emergency situation, there will be a simple and quick process followed to get the user online with the provider as quickly as possible, however, there may be some limitations to the feature functionality. The user will then scan the profiles of service providers 18 in several categories; i.e., tutoring (various skills), counseling, financial planning, etc. The user may also use sophisticated matching technology to find the best fit for their needs or they may also use and advanced an advanced services search engine offered by a third party (i.e. Google, Microsoft, etc.). In the case of the matching tool, the user fills out a questionnaire about desired needs and time/date preference and the matchmaking technology presents compatible providers based on need, time, availability, gender/age, and other data, including culture, geography, level of experience and education and other factors. Once the user has located the desired provider, they place a bid for the selected block of time 36 and if they win the bidding or they pay the “purchase now” price 38 then they are directed to the online payment area 40 to complete the financial transaction.

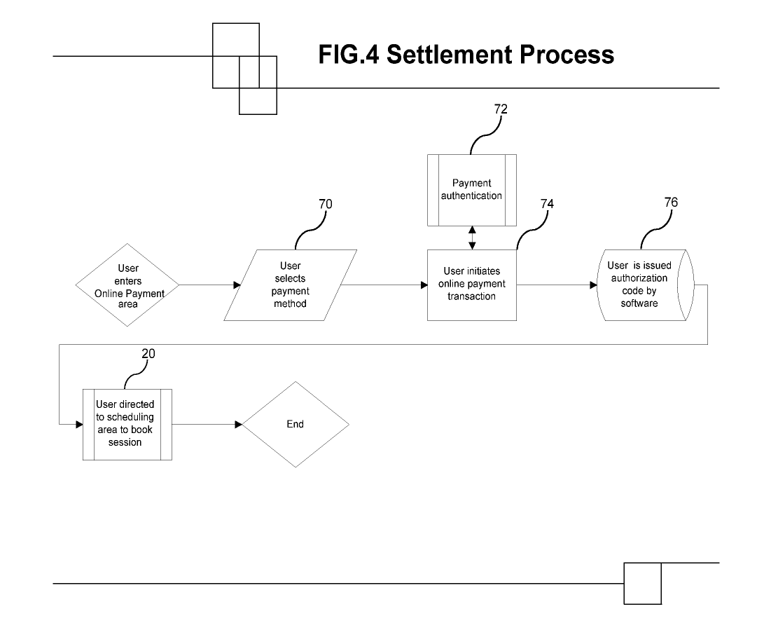

FIG. 4 depicts the settlement process whereby the user selects a payment method 70, initiates the payment transaction 74. The payment is authenticated by the financial service provider 72 and the user is issued an authorization code 76 or digital certificate. The user is then directed to the scheduling area 20 to register for session.

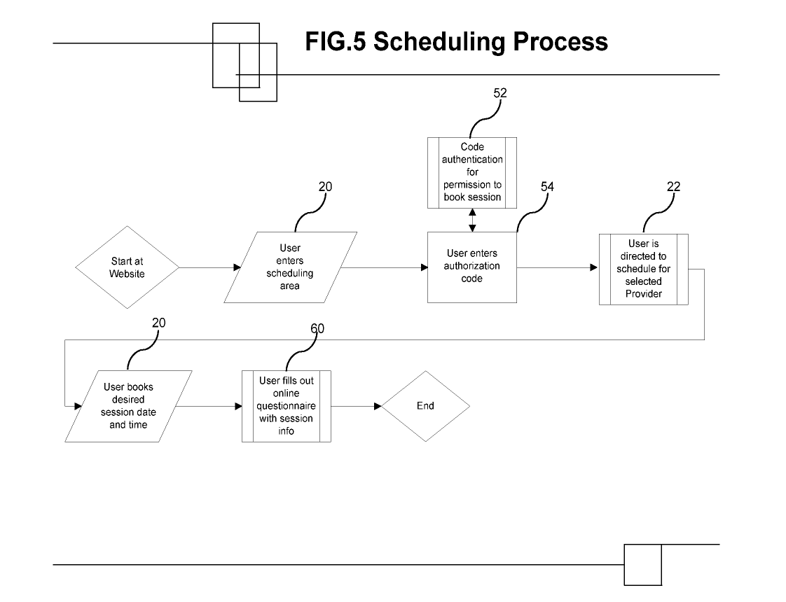

FIG. 5 depicts the scheduling process whereby the user enters the scheduling area 20 and inputs the provider name and the payment confirmation number 54 into the RSP. The system then authenticates the code and grants permission 52 to the user to book the session with the provider. The user is then directed to the specific schedule of the selected provider 22 and the user selects an available block of time 20. The scheduling system makes the appointment at desired time and requests that the user fill out an online questionnaire with the appropriate information 60 for the upcoming session with the provider. The provider receives a copy of the user questionnaire 60 to help them prepare for a productive session. The user may also choose the time and frequency of automatic e-mail reminders that they will get prior to the session.

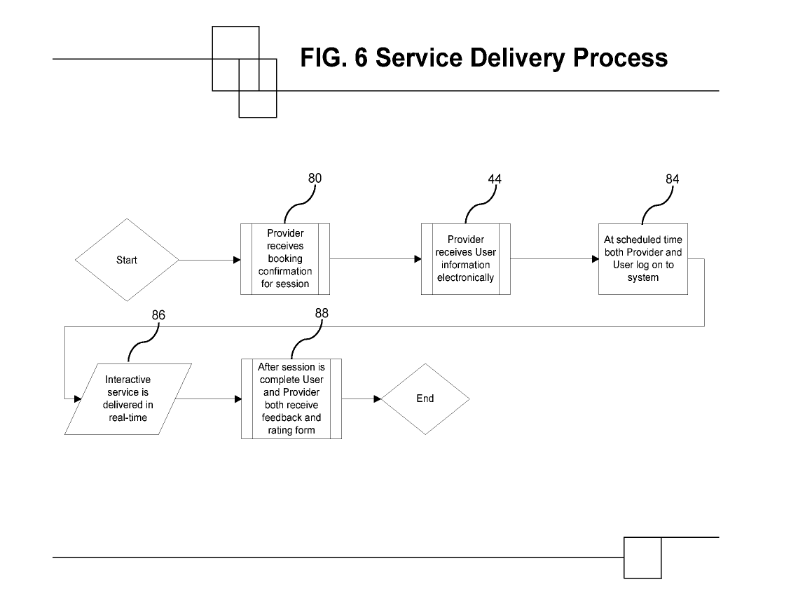

FIG. 6 depicts the service delivery process whereby the provider has received the booking confirmation for the session 80 and they have reviewed the user questionnaire 44 in preparation for the session. The session is initiated at the scheduled time and both the provider and the user log on to the system 84. The real-time interactive service is then delivered 86 to the user over the Global Communications Networks. Once the interactive session is complete, both the user and the provider may choose to fill out a feedback and rating form 88 to be used privately or to be summarized in a reporting or grading system. Should the user decide that they want to extend the interactive session once the initial block of time has expired, they may make a request of the provider to confirm their availability for an extension and, if confirmed, may extend the session by clicking on a simple pop-up box and re-confirming their authorization to be charged for the additional time using the same payment method as originally employed.

Depending on the particular commercial or non-profit application of the invention, there are many different combinations, modifications, or ways of deploying the modules and components described herein above that may include all or any part of the real-time services facilitator system and method without affecting or limiting the validity of the system except as may be required by any applicable law pertaining to the following claims:

What is claimed is:

1. A method and system enabling a user to access a database of professional service providers through the Global Communication Networks and mobile phones comprising the steps of: arriving at a website to browse the database of professional service providers; checking to see if any of the providers can meet the needs and demands of the user; reviewing profile ratings of the listed providers; checking for availability of providers; filling out a questionnaire listing user information, background, and specified need(s); using a search tool to locate a provider or multitude of providers for a user's specified needs based on subject area, category, availability, and other criteria; using a compatibility tool for an instant match and near match.

2. A method and system, as recited in claim 1, comprising the further steps of: choosing professional service providers or knowledge experts in order of preference; checking the availability of the selected providers; allowing the user to register and establish an account by creating a user ID name and password; providing encrypted personal and financial information, which will include form of payment such as credit card, pay pal, e-coupons, or monthly subscription; receiving an e-mail notification of approval or denial to register as a user; clicking on a hyperlink in the email which will take the user to the log on section of the website.

3. A method, as recited in claim 1, comprising the further step of logging onto the site with a user name and password.

4. A method, as recited in claim 1, comprising the further steps of: checking the availability of the preferred service providers; choosing a specific provider.

5. A method and system, as recited in claim 1, for bidding on a session or event with a provider via an online auction platform, comprising the further steps of: bidding for a real-time session or event with the chosen provider; deciding whether to purchase now for a locked in session with a provider or to participate in the bidding process, which could include placing incremental bids; receiving an email confirmation of the user's last bid and periodic updates of the bidding status and e-alerts when there are higher bids; placing a winning bid or clicking on the purchase now icon for an interactive session with a provider.

6. A method and system, as recited in claim 4, for scheduling a real-time session with a provider, comprising the further steps of: checking the service provider's calendar; setting a date and time for an interactive event or session with a provider.

7. A method and system, as recited in claim 5, for confirming a scheduled session with a provider, comprising the further steps of: logging onto the user account at the website and clicking on the confirm session button; receiving an email confirmation of the scheduled time with a provider.

8. A method, as recited in claim 7, comprising the further steps of: receiving periodic email reminders of the scheduled session with a provider.

9. A method and system, as recited in claim 6, enabling the user(s) to interact with a professional service provider or knowledge expert(s) in a real-time session via the global computer networks, comprising the further steps of: linking the user(s) and provider(s) over the global computer networks; facilitating real-time interaction and communication between user(s) and knowledge provider(s).

10. A method and system, as recited in claim 9, for delivering the services of the knowledge providers and experts to the users via the global computer networks, which could include mobile phones, PDAs, wireless text messaging, electronic bulletin boards or instant chat messaging.

11. A method and system enabling users to engage the expertise of providers in critical and emergency situations, comprising the further steps of: clicking on the emergency icon on the website after logging on; typing in a specified request; receiving a list of available providers and experts with their respective rates.

12. A method and system, as recited in claim 11, comprising the further steps of: choosing an available provider; purchasing a real-time session or event.

13. A method and system, as recited in claim 11, comprising the further steps of: linking the user(s) and provider(s) over the global communication networks; facilitating real-time interaction during the emergency session or event.

14. A method and system for enabling the user(s) to evaluate the real-time session and the selected service provider(s) or knowledge expert(s), comprising the further steps of: reviewing the service provider and rating the event or session; making comments and suggestions.

15. A method and system enabling the users to make referrals to other prospective users, with an incentive-based program, comprising the further steps of: providing the contact information of potential users; receiving e-coupons if the referrals participate in future real-time sessions with providers listed on the website.

16. A method and system, as recited in claim 14, for preferred users to receive updates, tips, and evaluations from service providers and experts, comprising the further steps of: becoming a preferred user after scheduling a set number of real-time interactive sessions with a provider; scheduling a minimum number of sessions with a provider or expert.

17. A method and system enabling users to participate in a group real-time interactive session with a provider or subject matter experts, comprising the further steps of: searching the database for providers who are available for group sessions; linking users to participate in a session for a specified common request and willing to share equally in the winning bid; scheduling a real-time interactive session or event; delivering the services of a group interactive session over the global communication networks, which could include electronic bulletin boards, online and chat forums, and instant messaging.

18. A method and system, as recited in claim 1, for providing monthly specials and matches based on a user's needs, comprising the steps of: sending email promotional specials, if the user has checked the request box on the website; enabling the user to engage in an interactive session with a provider, after making payment.

19. A method and system, as recited in claim 2, for procuring provider candidates, comprising the further steps of: offering a questionnaire and application on a website for provider candidates to complete; allowing registered providers to make referrals for potential providers.

20. A method and system, as recited in claim 2, for screening professional knowledge providers, comprising the further steps of: allowing the applicants to make an e-signature attesting that all the provided information is accurate; allowing the applicants to pay for their own individual background checks via pay pal, credit card, or electronic payment; completing a background check of the provider applicants, which will include criminal and educational background information.

21. A method and system, as recited in claim 19, for registering the providers, comprising the further steps of: sending an email to the applicants with the background results; providing a hyperlink in the email for the applicants to click on which will transfer them to a website, after successfully passing the background checks; enabling the providers to establish a log in user name and password; allowing the professional service providers and knowledge experts to create profiles listing areas of expertise, special interests, optional background information, optional photo, and level of experience.

22. A method and system, as recited in claim 20, wherein providers are listed in categories, comprising the further steps of: assembling a database of providers based on service offerings; e.g., law, education, health, etc; developing subcategories for the providers; (e.g., LAW-DIVORCE), (EDUCATION-TUTOR-LANGUAGES-SPANISH-ADVANCED-INTERMEDIATE-BEGINNER).

23. A method and system, as recited in claim 20, comprising the further steps of: creating a database of service providers based on expertise, experience, educational background, user rankings; providing alternative providers in certain categories in case selected providers or knowledge experts are not available at a requested time.

24. A method and system, as cited in claim 20, wherein provider applicants provide e-signatures of documents, as independent professional providers and contractors, comprising the further steps of: signing an encrypted confidential agreement; signing an exclusive contract with a non-compete clause; filling out employment documents and tax forms; agreeing to the employment terms.

25. A method and system, as recited in claim 2, wherein providers list their availability for scheduling purposes, comprising the further steps of: clicking on the calendar icon on their profiles and listing days and times for offering their services; enabling the providers and knowledge experts to offer instant availability by clicking on a green icon on their profiles.

26. A method and system, as recited in claim 2, wherein providers list their cost of their services, comprising the further steps of: enabling the providers to list their services at a starting bid and the time and day when the bidding time and the online auction is to conclude; letting the providers list their services with a purchase now option—which will result in winning the service offering of the provider.

27. A method and system, as recited in claim 17, wherein providers may collaborate with other registered providers on a specified project or request, if the user agrees, comprising the further steps of: giving providers access to the search engine to locate other providers with the required knowledge or skills; providing a method for revenue sharing or allocation among providers; enabling communication between providers prior to scheduled sessions where collaboration will occur.

28. A method and system, as recited in claim 27, wherein providers may offer their services via chat forums or electronic bulletins boards, comprising the further steps of: enabling multiple provider access to closed user sessions; creating a “time card” system to check providers in and out of chat rooms or bulletin boards for billing and tracking purposes.

29. A method and system, as recited in claim 17, for service providers and knowledge experts to interact with a plurality of users, comprising the further steps of: enabling point to multi-point real-time communication; creating a “time card” system to check users in and out of chat rooms or bulletin boards for billing and tracking purposes; facilitating communication among the users during a live interactive session.

30. A method and system for providers to extend the scheduled interactive real-time event or session, comprising the further steps of: allowing “1-click” authorization by the user agreeing to extend the session; triggering an additional financial transaction using the same information and source of funding as the original transaction upon extension approval by the user; allowing for provider acknowledgment of continued availability for extended session.

31. A method and system, as recited in claim 14, for providers to submit reviews, evaluations, feedback for the users comprising the further steps of: filling in automatic pop-up evaluation forms at completion of and event or session; preparing formal evaluations, grading, and/or ranking for ongoing user/provider relationships.

32. A method and system, as recited in claim 2, for providers to receive payment for their services, comprising the further steps of: providing automated payroll applications; making available an online database of payment history and pending payments; providing a menu of payment options to providers including pay pal, echeck, direct deposit, electronic payment.

33. A method and system, as recited in claim 2, for providers to receive bonus payments and employment incentives, comprising the further steps of: establishing the parameters for eligibility with an automatic action once the thresholds are met; enabling one-time or short-term incentive programs that can be easily and quickly implemented.
